(19) United States
(12) Patent Application Publication
(10) Pub. No.: US 2005/0181343 A1
(43) Pub. Date: Aug. 18, 2005

(54) Ultrasound guided vascular access training device

(76) Inventors: Mark J. Ault, Los Angeles, CA (US); Brian Ault, Los Angeles, CA (US)

Correspondence Address: JONES DAY, 555 WEST FIFTH STREET, SUITE 4600, LOS ANGELES, CA, 90013-1025, US

(21) Appl. No.: 10/771,170

(22) Filed: Feb. 2, 2004

(51) Int. Cl. G09B 23/28

(52) U.S. Cl. 434/272

(57) ABSTRACT

The invention provides a training aid for teaching venous or arterial puncture and line placement. It comprises model pressure-loadable veins and arteries having lifelike properties, including tactile sensation and accurate sonographic images that enable a trainee to learn to locate and access target vessels in real time by ultrasound. The present invention advantageously provides the trainee with instant feedback of having accessed the correct or wrong blood vessel by withdrawing different color fluids. The combination of realistic modeling of the vasculature, real-time feedback, and risk-free training environment allows for the development of proficiency in ultrasound-guided invasive medical techniques.

### FIELD OF THE INVENTION

The present invention relates to medical training devices for the insertion of catheters into the vasculature using ultrasound guidance.

### BACKGROUND OF THE INVENTION

Venous catherization is a widely used procedure with important applications in a variety of clinical settings, including parenteral nutrition, intravascular depletion, access for vasoactive medications, hemodynamic monitoring, cardiopulmonary arrest, and long term intravenous access for medications, such as antibiotics or chemotherapeutic drugs. Traditionally, venous line placement has been performed by highly experienced clinicians trained in using anatomic landmarks to identify the putative location of the invisible desired vein. Landmark-based line placement relies on the known relationship between palpable or visible anatomical structures and the target blood vessel. For example, infraclavicular insertion of a catheter into the subclavian vein requires correct localization of the clavicle reference site, suprasternal notch and sternocleidomastoid-clavicular triangle landmarks, proper positioning of the patient and operator and correct venipuncture point depth, direction and insertion angle. Similarly, insertion into the internal jugular vein requires thorough knowledge of this vein's course in relation to the sternocleidomastoid muscle and carotid artery.

One disadvantage of landmark-based techniques is that in order to be performed safely and reliably, they require years of study and practice by the clinician. Unless a practitioner has attained proficiency, landmark-based techniques of line insertion are associated with high rates of failure, some of which may carry undesirable complications for the patient. Another disadvantage of landmark-based line placement techniques is that they do not permit the prediction of anatomic abnormalities or variations between individuals. Thus, even a highly skilled and experienced practitioner may encounter difficulties in locating vessels that follow an atypical course or that are obscured by unusual amounts of adipose tissue, which may lead to repeat catheterization attempts. Such lengthy probing is stressful for both clinician and patient, and can potentially expose the patient to trauma and infection.

Because of the disadvantages associated with landmark-based line insertion techniques, ultrasound-guided line placement is gaining increased recognition in clinical medicine worldwide. Ultrasound-guided line placement allows the clinician to visually monitor insertion of the needle and catheter into the desired blood vessel in real time, thereby eliminating the imprecision associated with “blind” techniques. However, ultrasound-guided insertion techniques require the practitioner to be able to read and navigate complex real-time images of tissues, blood vessels and other anatomical structures. In addition, ultrasound guidance techniques exact considerable manual dexterity from the practitioner and therefore necessitate proper training. As with landmark-based techniques, the teaching of ultrasound-guided line insertion on patients is undesirable. However, to date there are no adequate simulators that would allow the risk-free training of medical personnel in line placement. It would thus be highly desirable to have a training device capable of simulating various types of blood vessels to enable medical professionals to develop proficiency in ultrasound-guided line insertion before performing such procedures on patients.

### SUMMARY OF THE INVENTION

The present invention pertains to devices, kits, and methods for training practitioners in vascular puncture and catheter insertion. The present invention is useful as a training aid for teaching central and peripheral line placement, as well as phlebotomy. It provides a vascular training device which allows life-like tactile sensation and sonographic monitoring during insertion of a needle or catheter into a desired blood vessel. In one embodiment, the training device comprises realistic model vasculature. The model vasculature is suitable for incorporation into a tissue model, such as animal-derived or synthetic tissue. The present invention may further include instructions for assembly of the vascular access training system.

One particular benefit of the present invention is its realistic modeling of different types of blood vessels, allowing clinicians to learn to distinguish between target and non-target vessels. Other benefits of the invention include its portability, reusability, and ease of assembly which make it suitable for large scale training programs, such as medical school curricula, resident training, or nurse/technician training programs. Additional advantages of the invention as described in the following drawings, detailed description, and claims will be apparent to one skilled in the art.

### BRIEF DESCRIPTION OF THE DRAWINGS

FIG. 1 depicts one representative embodiment of the present invention including a model vessel with connecting tube and two-way valve at one end and adaptor plug at the other.

FIG. 2 depicts the air-evacuation of the fully assembled model vessels prior to insertion into an exemplary tissue model, here a chicken.

FIG. 3 depicts the model vessel connected to a tunneler.

FIG. 4 shows how the model vessel and tunneler can be connected by a threading mechanism use of ultrasound guidance on the vascular model to locate target vessels.

FIG. 5 shows the insertion of the model vessel into a tissue model by use of the tunneler.

FIG. 6 shows how the model vessels are embedded inside the tissue model and the loading of the model vessels with fluid after insertion into a tissue model.

FIG. 7 shows use of the hand-held ultrasound device on a tissue model containing the vascular access training aid.

FIG. 8 is an ultrasound image of a model vessel of the vascular access training aid during simulated central line placement (transverse plane).

### DETAILED DESCRIPTION OF THE INVENTION

In the United States, physicians and medically trained personnel perform several million venous catheter insertions every year. Unfortunately, the use of central venous catheters is associated with adverse events that are both hazardous to patients and expensive to treat. (McGee et al., New England Journal of Medicine 348 (12): 1123-33, 2003). It has been estimated that almost 20% of central venous catheter insertions are unsuccessful and up to 10% result in medical complications. Of the complications that may arise from line placement, puncture-related injuries to non-target vessels and organs are among the most common. One reason for the frequency of inadvertent puncture of non-target vital structures is the high level of skill required to precisely locate target vessels. Indeed, operator experience is considered to be one of the most significant predictors of successful line placement.

While the US Agency for Healthcare Research and Quality has listed the application of ultrasound-guided insertion techniques as a major quality improvement goal for patient safety in central line placement, no formal mechanism currently exists for teaching the technique to the residents. Instead, trainees rely on their supervising residents for both landmark-based and ultrasound-guided training, despite the fact that the efficacy of the “see one-do one” method has recently been drawn into question. When the setting for learning procedures is in the actual patient care arena, patients become unsuspecting experimental subjects for interns who may have never placed a central or peripherally inserted line. Such a trial by fire approach increases the chances of well-known complications such as vessel damage, local hematoma, retroperitoneal or thigh bleeding, pneumothorax, hemothorax, AV fistula formation, local or disseminated infections, or needle sticks to the operator. In addition, because ultrasound-guided insertion techniques are relatively new, there are fewer experienced supervisors who are able to demonstrate the procedure to their trainees. As a result, ultrasound-guided central line placement remains largely underused in clinical practice.

The present invention thus fulfills an important need in clinical medicine by providing a realistic model upon which clinical trainees can practice the ultrasound-guided identification of target vessels and placement of central lines in a target vessel while avoiding injury to neighboring non-target vessels and surrounding structures. The present invention makes possible, for the first time, the practice and teaching of critical venipuncture and line placement skills to groups of trainees in a setting that avoids any risk to patients. At the same time, the present invention allows trainees to achieve proficiency in using ultrasound to identify, locate, and access target vessels, thus facilitating the recommended use of ultrasound guidance in vascular access procedures. Because the invention incorporates different types of blood vessels, trainees develop skill in differentiating between them. Thus, the present invention alleviates one of the most common problems in vascular access procedures: the unintended puncture of non-target vessels, such as arterial puncture when venous access is sought.

In one preferred embodiment, the present invention provides a vascular access training aid comprising a plurality of preassembled model blood vessels, preferably at least one model artery and one model vein. The model vessels are designed to have lifelike tactile properties upon needle insertion such that puncture of the model vessels with a needle will provide the trainee with a realistic sensation of vessel penetration. In the case of a vein, the model vessel is constructed of a thin sheath of elastic material shaped in the form of an elongated tube with a diameter that can be varied to suit the particular application. For an artery, the thickness of the material is slightly increased to reflect the thicker and more muscular wall of arteries. The difference in vessel wall thickness between model vein and artery is important in helping the trainee distinguish the two types of vessels. Because the present invention is particularly adapted for use with ultrasound imaging equipment, the thickness of the model artery will be discernible on ultrasound as a greater resistance to external pressure, such as that applied during operation of a hand-held ultrasound device, whereas the model vein will deform more readily under pressure. This differential behavior of model arteries and veins perfectly reflects that of their natural counterparts in vivo and enables the trainee to learn to confidently identify the type of vessel he/she is trying to access.

In a further preferred embodiment, the vascular model of the instant invention comprises one or more model veins and/or one or more model arteries having different diameters. The model veins and arteries are constructed of an elastic material configured into elongated tubes comprising lumens of various diameters. Suitable materials for the model vessels include natural rubber latex, thermoplastic elastomer (TPE), or polyvinyl chloride (PVC), and may further include silicone or other plastics known in the art. Depending on the application, the sizes of the vessel lumens can be varied from 1-2 mm in diameter to reflect the sizes of peripheral and pediatric vessels to over several inches in diameter for very large vessels that can be used to train clinicians in veterinary practice, for example. As a consequence, the vascular model of the present invention can accommodate a wide variety of blood vessel types and thus simulate a great number of different anatomical locations and applications. In this manner, trainees can learn to navigate and distinguish sonographically different vessel types and sizes.

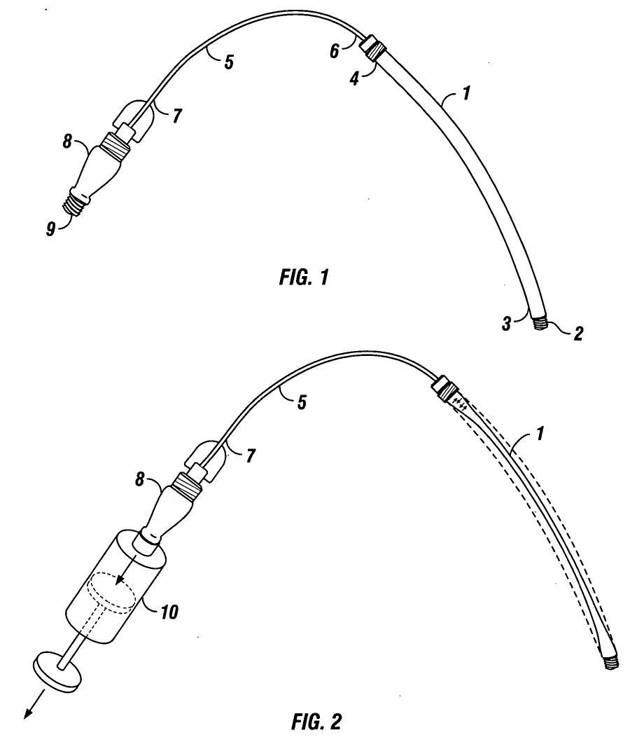

As shown in FIG. 1, the model vessels (1) can be conveniently filled with fluid to emulate the properties of natural blood vessels. In order for the model vessels (1) to hold and retain the fluid, their ends are sealed, which can be accomplished by tying, gluing, fusing or otherwise affixing the vessel material around a solid adapter plug (2) inserted into the lumen at the distal end (3) of the vessel. In addition, the proximal end (4) of the model vessel is attached to a small diameter connecting tube (5) of variable length. The connecting tube (5) is preferably transparent to allow visual inspection of the fluid contained within its lumen. The lumen of the connecting tube (5) is continuous at its proximal end (6) with the lumen of the model vessel. The distal end (7) of the connecting tube (5) can further be connected to a self-sealing two-way valve (8). The two-way valve (8) facilitates the evacuation of air from the model vessel (1) and connecting tube (5), as well as the loading of the lumen of the model vessel (1) with solution, as by the use of a syringe. The valve (8) may comprise threading (9) to accommodate a threaded syringe tip, to prevent accidental slipping of the syringe during fluid injection. In addition, because the valve (8) is a two-way valve, any fluid that is added to the vessel lumen will be retained therein after the filling syringe is removed.

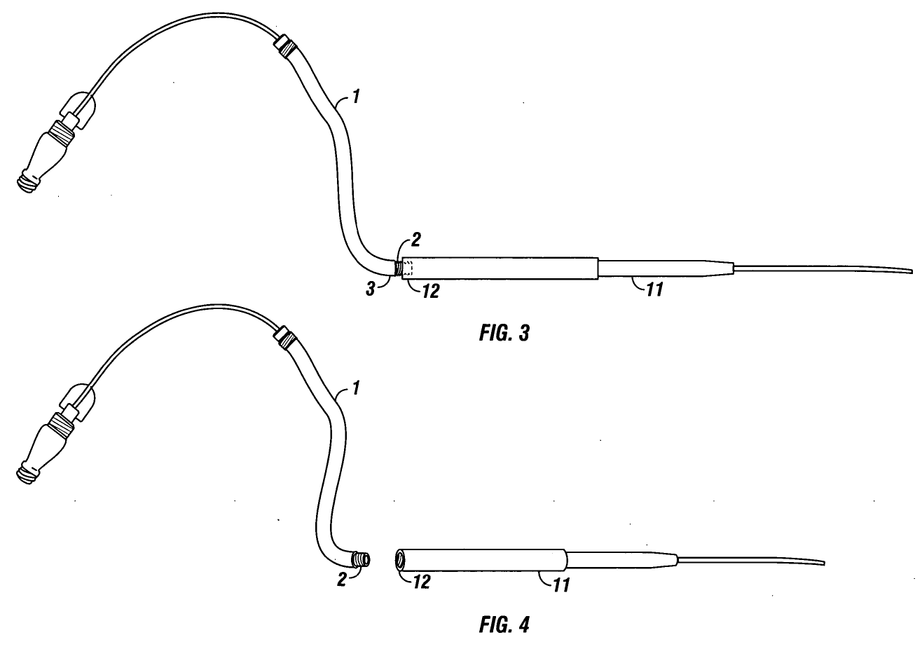

The fully assembled model vasculature can now be inserted into a tissue model. Suitable tissue models for purposes of the instant invention include non-living animal tissues, such as whole chicken, turkey, pig, or beef, and may also comprise sonographically acceptable surrogate tissue surrogate materials. For most human vasculature modeling, a tissue model the size of a whole chicken is sufficient, whereas for large animal veterinary training a larger tissue model may be preferable. Insertion of the model vasculature into a tissue model is one of the crucial steps in the assembly of the training device because ultrasound waves are unable to penetrate air and will yield unreadable images upon encountering air. The avoidance of air pockets during the insertion of the model vasculature is therefore one of the key advantages of the present invention. As shown in FIG. 2, the fully assembled model vessels (1) can be air-evacuated by the use of a syringe (10) that threads onto the two-way valve (8) located at the distal end (7) of the connecting tubing (5) of the model vessel (1). This allows the model vessel (1) to collapse and serves to minimize the diameter of the vessel tubing in preparation for insertion. The self-sealing two-way valve (8) will maintain the vacuum inside the model vessel (1) and keep its diameter to a minimum until the fluid loading step. As shown in FIG. 3, before insertion, the evacuated model vessel (1) is connected to a tunneler (11), which is preferably accomplished by a male-female connection or threading of the tunneler's (11) proximal end (12) to the model vessel's sealing plug (2) at its distal end (3).

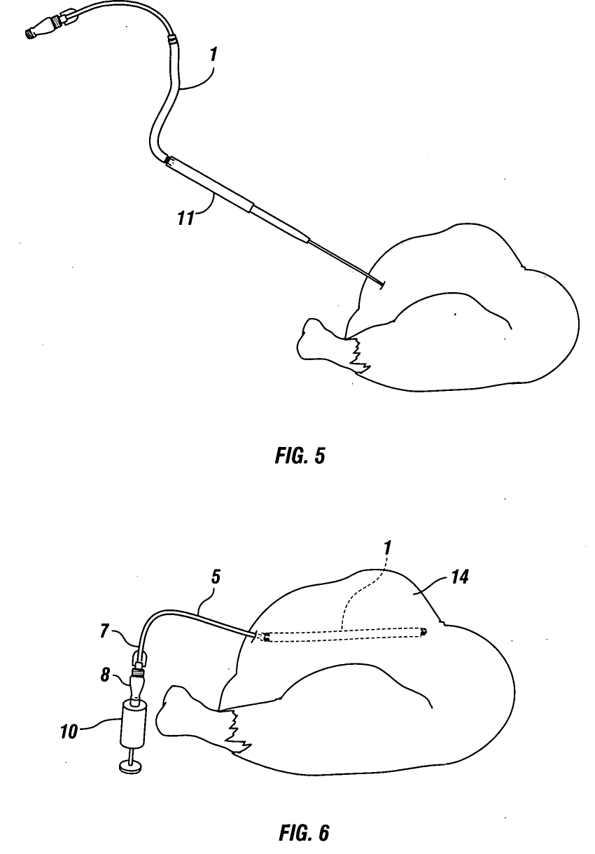

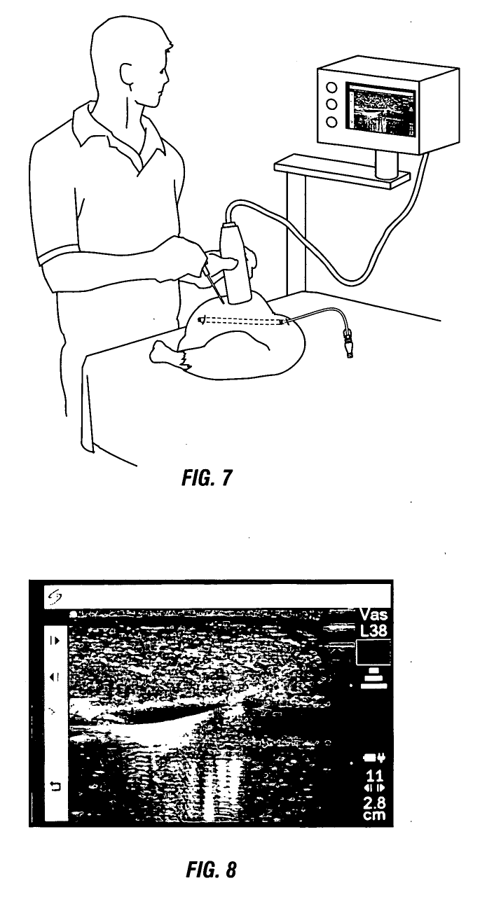

Thus, in another preferred embodiment shown in FIG. 4, the present invention provides a tunneling device (11) for positioning the model vessel (1) within a tissue. The tunneling device (11) is an elongated rigid rod comprising a distal end (13) used to pierce the tissue and a proximal end (12) having a connecting mechanism for the attachment of the model vessels. The connecting mechanism is designed to thread or push-on to the corresponding distal, sealed end (3) of the model vessel. A preferred tunneler (11) is designed to taper, increasing slightly in diameter from insertion tip at its distal end (13) to vessel connecting proximal end (12). The tunneler (11) can be straight or bent. As seen in FIG. 5, once the tunneler (11) is connected to the model vessel (1), it is inserted into the tissue model (14) and pushed through at a desired distance below the surface. Thus, for the modeling of internal vessels, the tunneler (11) can create a path through the tissue at 1-2 cm or more below the surface, whereas for the modeling of superficial vessels the tunneler (11) can create a path closer to the tissue surface. The length of the tunneler (11) varies with the type of tissue model (14) used. In the case of a whole chicken tissue model, the tunneler (11) is preferably about 9 inches in length. This length would be increased if insertion into a larger tissue model is desired. It is an advantage of the present invention that the diameter of the tunneler (11) does not depend on the diameter of the model vessel to be inserted and can be kept rather small, such as 3 mm or even less, thereby minimizing the size of the hole created in the tissue. Thus, the present invention allows the insertion of a variety of sizes of model vessels.

In an alternative embodiment of the present invention, the insertion of the model vessels can be accomplished by the use of a sheath tunneler and a cable comprising a clamping device. The sheath tunneler is pushed into the tissue model at the desired depth and the tunneler is retracted, leaving the sheath inside the tissue. The cable comprising the clamping device is inserted through the sheath and the clamp is activated to attach to the distal end of the model vessel. The cable is used to pull the model vessel through the tissue, displacing the sheath in the process. Suitable clamping cables are well known in the art and may comprise biopsy forceps.

As FIG. 6 shows, once the model vessels (1) are embedded in the tissue model (14), they are preferably no longer visible, with only the clear connecting tubes (5) extending out of the tissue model (14). Thus, the length of the model vessels (1) is preferably determined by the size of the tissue model (14) chosen, such that for a whole chicken, the length of the vessels would typically not exceed 9 inches. The clear connecting tubes (5) extending out of the tissue model (14) can then be used to fill the model vessels with fluid. This can be accomplished by attaching a syringe (10) to the self-sealing two-way valve (8) located at the distal end (7) of the connecting tube (5). The valve (8) may comprise standard threading to accommodate a threaded syringe tip. The fluid-loaded syringe (10) is then used to fill the model vessels with fluid. One important advantage of the instant invention is its design which allows the pressurization of the fluid-filled vessels. Because the two-way valve (8) will retain the fluid inside the vessel lumen, the model vessels can be filled with sufficient fluid so as to increase the diameter of the vessels. This step serves to ensure that the model vessels completely fill the holes created in the tissue by the use of the tunneler (11). Thus, the present invention eliminates the occurrence of air pockets inside the tissue model which would render the sonographic image unreadable. It should be noted that the present invention advantageously avoids inconvenient manipulations such as underwater vessel insertion to prevent air pocket formation.

In one preferred embodiment, the model arteries and model veins of the present invention are filled with fluids of different color. This advantageous feature of the invention permits instantaneous feedback for the trainee as to whether he has punctured the intended vessel. For example, a trainee attempting to insert a needle or catheter into a vein will be able to confirm successful puncture of the intended vein by drawing, as an example, blue fluid, whereas if he had punctured the model artery instead, he would draw red fluid. This confirmation of having targeted the correct vessel is an important advantage of the present invention that provides the trainee with invaluable instructional feedback, allowing him to hone his skill by repetition until he attains proficiency.

In yet another preferred embodiment of the instant invention, the fluid filling the lumens of the model vessels can be made to circulate by connecting the model vessels to one or more pumps, forming a closed circuit. To simulate venous blood flow, the pump connected to the model veins may be set at a slower pace, whereas the pump connected to the model arteries may be set to a higher level pace in order to create more artery-like, pulsatile flow. The distinction in flow characteristics of the arterial versus venous vessels is designed to further teach the trainee to sonographically discriminate between the two types of vessels, as the model arteries may reflect the pulsatile flow of fluid coursing through their lumens, whereas the model veins are less dynamic.

In another preferred embodiment of the invention, a thrombotic venous model is provided to teach the trainee how to recognize and avoid thrombotic vessels. For this purpose, a model vein is filled with gelatin to reflect sonographically the presence of an opaque thrombotic occlusion.

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or devices without the exercise of inventive capacity and without departing from the scope of the invention.

### EXAMPLE 1

### Construction of the Model Vessels

Flexible tubing, such as surgical draining tubing, selected at a thickness of 0.010 cm to 0.015 cm for a model vein, and of 0.020 cm to 0.060 cm for a model artery, is cut to a desired length, such as 9 inches for insertion into a whole chicken tissue model. The diameter of the tubing depends on the particular vascular simulation. For human neck or femoral vasculature modeling, suitable diameters range from 3/16 inches to ⅜ inches. One important consideration in selecting the tubing is that the material be both pliant and yet firm enough to withstand repeat puncture. Thus, natural rubber latex is a preferred material because of its elasticity and comparative ability to self-seal after puncture. Once the tubing has been cut to the desired length, one end (distal) of the tubing is sealed closed. This can be accomplished by tying the vessel end around a plug adaptor made of a rigid material, such as plastic, sized to fit into the vessel lumen. The string used for tying is preferably a heavily waxed cotton fiber that will not slip off the rubber and is able to maintain an airtight pressurized water seal. Alternatively, the vessel end can be sealed by inserting a contact adhesive, such as epoxy glue, which will harden into a sealing plug. Next, the remaining, or proximal, open end of the tubing is connected to a clear connecting tube, such as an IV extension tube. The diameter of the connecting tube is preferably smaller that that of the model vessel, to minimize the amount of fluid to be contained therein while allowing visual inspection of the color of the fluid. The end of the connecting tube proximal to the model vessel preferably comprises a rigid adapter region designed to fit the lumen of the model vessel. In this way, the connecting tube can be securely tied or glued to the model vessel. The end of the connecting tube distal to the model vessel preferably comprises a self-sealing two-way valve that remains patent at elevated fluid pressure levels (up to approximately 75 psi). The two-way valve comprises threading to allow the secure attachment of a syringe for the filling and re-filling of the model vessel. Once the syringe is threaded onto the two-way valve, the valve opens to allow the movement of air or fluid between the syringe and the model vessel. Upon detachment of the syringe, the valve closes and the fluid or vacuum is retained in the model vessel. This allows for control of the diameter of the model vessel, such that it can be minimized by creation of a vacuum inside the vessel during insertion into a tissue model, and it can be increased by the pressurized addition of fluid to the inserted vessel, such that the vessel wall is allowed to seal tightly against the surrounding tissue.

### EXAMPLE 2

### Insertion of the Model Vasculature into a Tissue Model

A tissue model, preferably containing anatomical structures, such as bones, is chosen for the insertion of the model vasculature. As a convenient example, a whole chicken may be used. However, for veterinary applications, for example, a larger tissue model, such as a turkey or a pig, may be preferable. The inclusion of anatomical structures provides the trainee with a realistic training model for ultrasound-guided vascular access procedures. The fully assembled model vasculature comprising at least one model artery and one model vein is air-evacuated in preparation for insertion into the tissue model. Air evacuation serves to reduce the diameter of the vessel and to minimize the hole created in the tissue model. A standard syringe is threaded onto the two-way valve located at the end of the connecting tubing that is distal to the model vessel and air is withdrawn from the model vessel lumen. Once the air has been removed from the vessel lumen, the syringe is unthreaded and the self-sealing two-way valve continues to maintain the vacuum inside the model vessel, keeping its diameter to a minimum until the insertion of the vasculature into the tissue model is completed. The distal end of the model vessel is subsequently attached to the end of a tunneler. The attachment can be through a male-female connection between the end of the tunneler and the distal adapter plug of the model vessel. Alternatively, the distal adapter plug of the model vessel can be threaded onto the tunneler.

Once the tunneler and model vessel are firmly connected, the tip of the tunneler, which can be sharp or blunt, is used to pierce the tissue and to forge a path through the tissue at a desired distance below the surface. The model vessel follows the path created by the tunneler and is thus pulled through the tissue until just before its distal end connected to the tunneler emerges. At that point, the tunneler is detached from the distal end of the model vessel and the insertion is complete. This process is repeated for each model vessel to be inserted. The depth of vessel insertion can be varied depending on the type of application—for phlebotomy applications, the insertion of the model vessels would be performed close to the tissue surface. For beginners' vascular access training aids, the model vessels may comprise only a model vein and model artery, spaced apart by several centimeters. For more advanced models, the vasculature may comprise model arteries and veins varying in size and spaced more closely. Even more challenging models may comprise model veins and arteries that cross over each other's paths, requiring a high level of skill by the trainee to identify and distinguish target vessel from non-target vessel on ultrasound.

Once embedded in the tissue model, the model vessels are filled with different color fluid. The ends of the clear connecting tubes extending out of the tissue model comprising threadable two-way valves are attached to threadable syringes filled with fluid of different colors and the fluid is injected into the model vessels. Injection of fluid into the model vessels inflates the diameter of the vessels until the vessel walls are flush against the surrounding tissue, eliminating any air pockets that could interfere with the sonographic image of the vascular access training aid. The pliant vessel walls allow model vessels to extend in diameter with increasing fluid pressure, while the self-sealing two-way valve maintains the fluid pressure after removal of the filling syringe. To fill a 9 inch long model artery with a lumen diameter of 3/16 inches approximately 8 cc of fluid are required, whereas a model vein of the same length and diameter can accommodate approximately 17 cc.

### EXAMPLE 3

Ultrasound-Guided Vascular Access Training

Once the training vasculature is in place and has been loaded with fluid, trainees can begin to practice ultrasound-guided vascular access techniques. For this purpose, a hand-held ultrasound device is applied to the surface of the vascularized tissue model and the trainee locates the model vessels on the sonographic image displayed on a screen. After locating the vessels, the trainee can distinguish a model artery from a model vein by pressing down onto the tissue with the hand-held ultrasound device. The model artery will be relatively resistant to the pressure and retain its circular shape, while the model vein will deform more readily upon application of pressure. While still holding the ultrasound device and monitoring the sonographic image, the trainee can then insert a needle into the tissue model. Because the needle and its tip are visible on ultrasound, the trainee can visually follow its path as he/she guides it toward the target vessel. Needle insertion into the target vessel is monitored sonographically and confirmed by the withdrawal of the right color of fluid from the punctured vessel. Repeated trials can help the trainee to gain familiarity with the ultrasound image and improve his/her hand-eye coordination skills. When necessary, the model vessels can be conveniently reloaded by injecting more color fluids through the two-way valve located at the end of the connecting tubing distal to the model vessel and that remains external to the tissue model for ease of access.

The preceding details are provided for example only. Other variations of the claimed inventive concepts will be obvious to those skilled in the art. Adaptation or incorporation of alternative devices and materials, present and future is also contemplated. The intended scope of the invention is defined by the following claims.

1. A vascular access training aid comprising:
a plurality of model vessels, said model vessels comprising a lumen, a proximal end, and
a distal end.

2. The vascular access training aid according to claim 1, wherein said proximal end is attached to a connecting tube comprising a two-way valve.

3. The vascular access training aid according to claim 2, wherein said distal end is sealed by an adapter plug.

4. The vascular access training aid according to claim 1,
wherein said model vessels comprise a model vein and a model artery.

5. The vascular access training aid according to claim 4,
wherein said model vein and said model artery are made of a pliant material.

6. The vascular access training aid according to claim 5, wherein said pliant material is selected from the group consisting of rubber, latex and silicone.

7. The vascular access training aid according to claim 4, wherein said model vein has a wall thickness ranging from about 0.010 cm to about 0.015 cm.

8. The vascular access training aid according to claim 4, wherein said model artery has a wall thickness ranging from about 0.020 cm to about 0.060 cm.

9. The vascular access training aid according to claim 1, further comprising
a tunneling device for positioning said model vessel within a tissue.

10. The vascular access training aid according to claim 9, wherein said tunneling device comprises a proximal end and a distal end.

11. The vascular access training aid according to claim 10, wherein said proximal end of said tunneling device is designed to removably connect to the adapter plug sealing the model vessel's distal end.

12. A vascular access training kit comprising the vascular access training aid of claim 9 and further comprising instructions for assembly and use.
